(19) United States
(12) Patent Application Publication
(10) Pub. No.: US 2024/0292790 A1
(43) Pub. Date: Sep. 5, 2024

(54) TREE PRUNER

(71) Applicant: Fiskars Finland Oy Ab, Espoo (FI)

(72) Inventors: Niko Rusanen, Espoo (FI); Mikko Heine, Espoo (FI); Erkki Seppäläinen, Kauniainen (FI); Pekka Lemmetyinen, Salo (FI); Thomas Nyholm, Helsinki (FI)

(21) Appl. No.: 18/115,841

(22) Filed: Mar. 1, 2023

(51) Int. Cl. A01G 3/033; A01G 3/037

(52) U.S. Cl. CPC A01G 3/0335; A01G 3/037

(57) ABSTRACT

A tree pruner includes a pruner body having a first body section and a second body section spaced apart in a longitudinal direction, a blade system connected to the first body section and having a first blade and a second blade that co-operate and for cutting branches, and a drive mechanism is provided in the second body section and includes an operating switch for actuating the first blade and/or the second blade. The operating switch has at least two actuation modes, so that by a first actuation of the operating switch, the blade system moves from a blades-open position to a gripping position and stays in the gripping position, and by a second actuation of the operating switch, the blade system moves from the blades-open position to a cutting position, wherein the gripping position is between the blades-open position and the cutting position.

### TECHNICAL FIELD

The present invention relates to a garden tool, and more precisely to a tree pruner.

### BACKGROUND

Conventionally, tree pruners have only two positions: a blades-open position, which is typically also a resting position when there is no actuation from the user, and a cutting position, which is actuated by the user and two blades being moved towards each other, resulting in severing a workpiece such as a branch from a tree.

One of the disadvantages associated with the known tree pruner is that in a situation where the cut branch is high up in the tree, it is challenging and usually time consuming to separate it from the other branches so it could be brought down in a safe manner. Typically, one has to push the cut branch or shake the surrounding branches for the cut branch to drop. This may cause an unpleasant situation, where the cut branch may fall on the user, or when shaking other branches, debris or insects from the branches may land on the user.

### SUMMARY

An object of the present invention is to provide a tree pruner so as to alleviate the above disadvantage. The objects of the invention are achieved by a tree pruner which is characterized by what is stated in the independent claim. The preferred embodiments of the invention are disclosed in the dependent claims.

The invention is based on the idea of providing the tree pruner with an option to grab the branch and in a safe and controlled way to separate the cut branch from the tree.

### BRIEF DESCRIPTION OF THE DRAWINGS

In the following the invention will be described in greater detail by means of preferred embodiments with reference to the attached drawings, in which

FIG. 1 shows a tree pruner according to an embodiment of the invention;

FIG. 2 shows the tree pruner of FIG. 1 in another operating position in which a telescopic structure of the tree pruner is in an extended state;

FIG. 3 shows a cross section of a second end of the tree pruner of FIG. 1 as seen from right side;

FIG. 4A shows a perspective view of a first end of the tree pruner of FIG. 1 as seen from above in a blades-open position;

FIG. 4B shows a perspective view of the first end of the tree pruner of FIG. 1 as seen from above in a gripping position;

FIG. 4C shows a perspective view of the first end of the tree pruner of FIG. 1 as seen from above in a cutting position.

### DETAILED DESCRIPTION

FIG. 1 shows a tree pruner comprising a pruner body and a blade system. The pruner body comprises a first body section 11 and a second body section 12 spaced apart in a longitudinal direction of the pruner body. The blade system is connected to the first body section 11, and comprises a first blade 21 and a second blade 22 adapted to co-operate with each other for cutting branches.

The first blade 21 and the second blade 22 are adapted to move relative to each other such that the blade system has at least a blades-open position and a cutting position. In FIG. 1, the blade system is in the blades-open position.

The first blade 21 may be stationarily connected relative to the first body section 11. The stationary connection may be implemented using known techniques, such as bolts and nuts or other fasteners. The second blade 22 may be rotatably connected relative to the first body section 11. The rotatable connection may be implemented using a pivotable joint 23. The first blade 21 and the second blade 22 are adapted to co-operate as bypass blades for cutting branches. In an alternative embodiment, the first blade and second blade are adapted to co-operate as anvil blades for cutting branches.

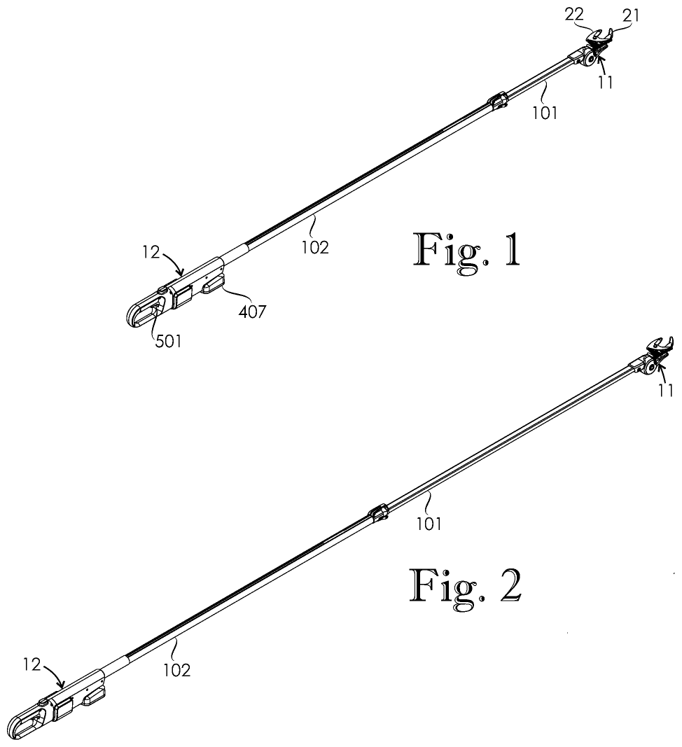

The pruner body may have a telescopic structure such that a distance between the first body section 11 and the second body section 12 is adjustable. FIG. 2 shows the tree pruner of FIG. 1 in another operating position in which the telescopic structure of the tree pruner is in an extended state compared to the one shown in FIG. 1.

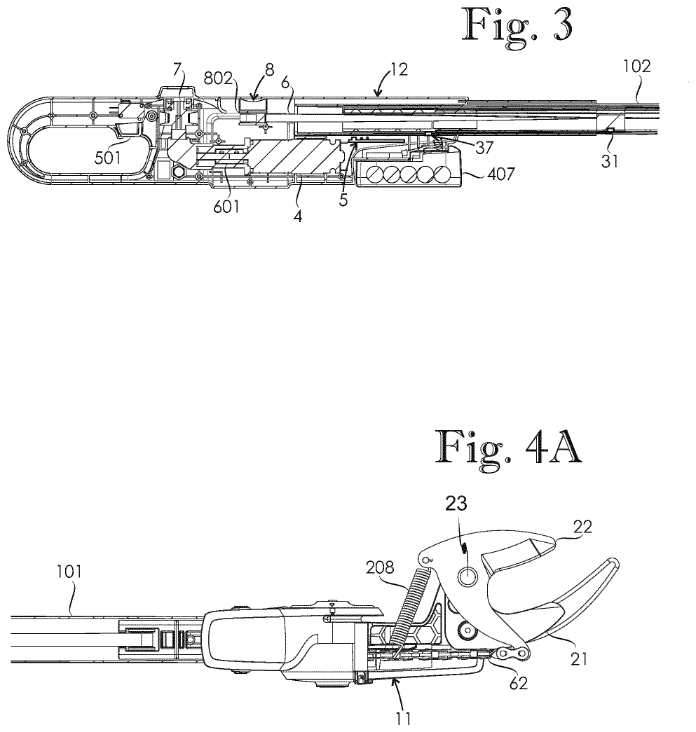

FIG. 3 shows a cross section of a second end as seen from right side. The tree pruner may be an electric tree pruner comprising a drive mechanism in the second body section 12. The drive mechanism comprises an operating switch 501, adapted to be manually operated, for actuating at least one of the first blade 21 and the second blade 22. In the accompanying Figures, the drive mechanism is configured to actuate the second blade 22.

The drive mechanism may further comprise an electric motor 4, a control system 5 adapted to control the electric motor 4, and a transmission system adapted to transfer power from the electric motor 4 to the blade system.

The electric motor 4 is connected to the second body section 12, and is adapted to provide driving power for the blade system. Rotation of the electric motor 4 in a first direction is adapted to provide an operation movement in which the blade system moves from the blades-open position towards the gripping position or the cutting position. A battery 407 is adapted to provide power to the electric motor 4.

The control system 5 is adapted to control the electric motor 4 to rotate in the second direction as a response to a situation in which a user of the tree pruner releases grip from the operating switch 501. This automatic operation is adapted to return the blade system to the blades-open position if the user of the tree pruner stops a cutting action before the blade system reaches the cutting position. In an alternative embodiment, the control system 5 is adapted to control the electric motor 4 to rotate in the second direction as a response to a situation in which a user of the tree pruner deactivates the operating switch 501.

The transmission system is adapted to transfer power from the electric motor 4 to the blade system. The transmission system may comprise a reduction gear 601, a rope reel 7, a transmission rope 6 and a transmission chain 62. The transmission rope 6 is provided at least partially inside the pruner body and connects the blade system and the drive mechanism.

The pruner body may comprise a first hollow tube 101 and a second hollow tube 102 such that the first tube 101 extends partially inside the second tube 102 in order to provide the telescopic structure of the pruner body. The transmission rope 6 extends inside the first tube 101 and the second tube 102.

The transmission rope 6 may comprise non-metallic synthetic material, such as aramid material, or/and comprises a woven part. A cross section of the transmission rope 6 may be rectangular such that a width of the transmission rope 6 is greater than a thickness thereof. In an embodiment, a width of the transmission rope is greater than or equal to 300% of a thickness of the transmission rope. In an alternative embodiment, a cross section of the transmission rope is circular.

The rope reel 7 is adapted to receive a portion of the transmission rope 6 around it, and the electric motor 4 may be adapted to rotate the rope reel 7. Herein, expression “transmission rope” is intended to cover all flexible elongated structures which can be wound on a rope reel, and which are capable of transferring power from the electric motor to the blade system. Therefore, expression “transmission rope” covers a string and a belt, for example.

The drive mechanism may further comprise a tension management system 8 communicatively connected to the control system 5 and is adapted to detect a slack rope situation in which tension of the transmission rope 6 is below a predetermined limit value. The control system 5 is adapted to prevent rotation of the electric motor 4 in a second direction opposite to the first direction as a response to detection of the slack rope situation. Thus, the tension management system 8, together with the control system 5, is adapted to reduce a risk of the transmission rope 6 getting fouled.

The tension management system 8 comprises a spring-loaded rope tensioner 802. The tension management system 8 is adapted to detect the slack rope situation based on a position of the spring-loaded rope tensioner 802. The spring-loaded tensioner may comprise a known tensioner.

The spring-loaded rope tensioner 802 is adapted to receive a tensioning length of the transmission rope 6 such that the spring-loaded rope tensioner 802 is capable of compensating a stretch having a length of the tensioning length. The tensioning length is 30 mm. In an alternative embodiment, the tensioning length is in a range of 15-100 mm.

The tensioning length is less than or equal to 50% of the length of the operation movement. In an alternative embodiment the tensioning length is less than or equal to 25% of the length of the operation movement.

In an embodiment, the tension management system is adapted to provide a slack rope alert to a user of the tree pruner as a response to a detected slack rope situation. The slack rope alert comprises an audio signal and/or a visual signal.

The tree pruner may further comprise a position detection system comprising a first locating mark element 31 connected to the transmission rope 6, and a position sensor 37 connected to the second body section 12 such that the first locating mark element 31 and the position sensor 37 are adapted to co-operate for detecting the cutting position.

The first locating mark element 31 and the position sensor 37 are adapted to co-operate for detecting the cutting position. The control system 5 is adapted to stop rotation of the electric motor 4 in the first direction as a response to detection of the cutting position. In another embodiment, the control system is adapted to stop rotation of the electric motor in the first direction, and to control the electric motor to rotate in the second direction as a response to detection of the cutting position. This automatic operation is adapted to return the blade system to the blades-open position after a cutting action.

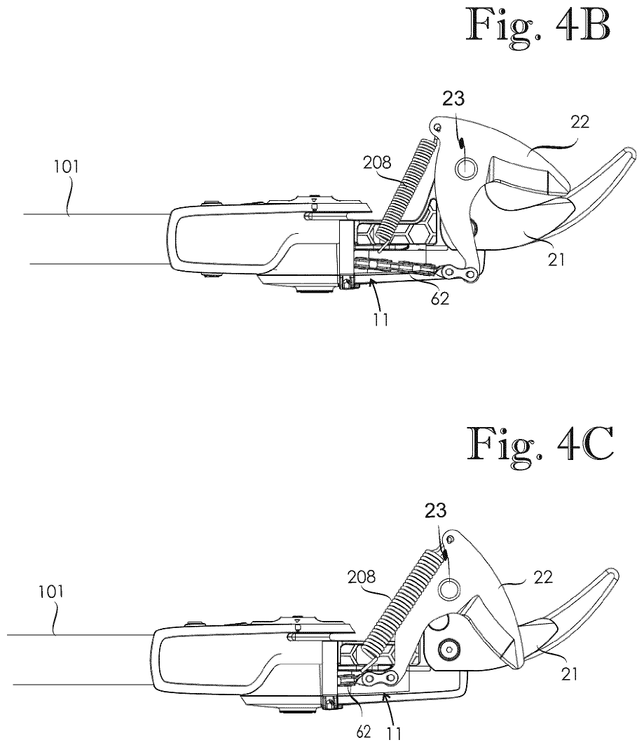

FIGS. 4A-4C show perspective views of the second end as seen from above. FIG. 4A shows the blades-open position, FIG. 4B shows the gripping position, and FIG. 4C shows the cutting position.

In the blades-open position, the first blade 21 and the second blade 22 form a bight which narrows towards the bottom of the bight. In the gripping position, the first blade 21 and the second blade 22 are closer to each other compared to the blades-open position. The tips of the first blade 21 and the second blade 22 may touch each other or almost touch each other forming a strait. In the cutting position, the first blade 21 and the second blade 22 have moved in relative to each other wherein the second blade 22 has at least partially passed the first blade for severing the workpiece between the blades.

A first end of the transmission rope 6 can be connected to the blade system through the transmission chain 62. A spring 208 coupled to the second blade 22 may bias the second blade 22 towards the blades-open position. A second end of the transmission rope 6 is connected to the drive mechanism, for instance to the electric motor 4 such that rotation of the electric motor 4 in the first direction is adapted to pull the first end of the transmission rope 6 towards the second body section 12 in the longitudinal direction. By pulling the transmission rope 6 the spring 208 extends and is tensioned. In an alternative embodiment, a first end of the transmission rope is directly connected to the blade system.

The first body section 11 may be adapted to be rotated relative to the second body section 12 around a rotation axis perpendicular to the longitudinal direction of the pruner body. For instance, in FIG. 4A said rotation axis is vertical.

The blade system is adapted such that a movement of the blade system, such as the movement between the blades-open position and the gripping or cutting position, and the movement between the gripping position to cutting position, is provided by an operation movement of the first end of the transmission rope 6. A length of the operation movement is 350 mm. In an alternative embodiment, a length of the operation movement is in a range of 100-500 mm.

The operating switch has at least two actuation modes, wherein by first actuation mode, the blade system is configured to move from a blades-open position to the gripping position and stay in said gripping position. In the gripping position, the blades may be releasably locked in said position unless the user releases/deactivates the operating switch 501 so the blades return to the blades-open position. In an alternative embodiment, the operating switch is configured to stay in the first actuation mode without active operation from the user.

The control system 5 is further adapted to control the electric motor 4 to prevent rotating or stop the rotation as a response to a situation in which the user of the tree pruner actuates the first actuation mode.

In FIG. 3, the operating switch 501 is illustrated as a trigger switch having at least two action steps, wherein by pressing mid-way is the first step and pressing all the way is the second step. In praxis, the user may actuate the first actuation mode by pressing the operating switch 501 half-way. By releasing/deactivating the operating switch 501, the blades are configured to return to the blades-open position. The operating switch 501 may alternatively stay in the first actuation mode even when the user no longer touches the operating switch 501. This helps the user to concentrate on operating the tree pruner and bring the cut branch safely down.

By actuating the second actuation mode, the blade system is configured to move from the blades-open position to a cutting position. In the operating switch 501 illustrated in FIG. 3, the user can activate the second actuation by pressing the operation switch 501 all the way down bypassing the first actuation mode, when the user wants to cut a branch and there is no need for gripping the branch.

The user can release/deactivate the operating switch 501 whereby the blades system is returned from the cutting position to the blades-open position. Deactivating the operating switch 501 can be done by an additional deactivation switch connected to the drive mechanism, or in a simpler way spring-biasing the operating switch 501 for returning to the initial position.

The operating switch 501 may further have a third actuation mode, wherein by the third actuation the blade system is configured to move from the gripping position to the cutting position. In praxis, the user can activate the third actuation by pressing the operation switch 501 from the first actuation mode (mid-way) to all the way down. The second actuation mode may be a combination of the first actuation mode and the third actuation mode.

The operating switch 501 illustrated in FIG. 3 shows a trigger switch for selectively engaging and disengaging the electrical coupling between the battery 407 and the electric motor 4. However, in an alternative embodiment, it can be a rocker switch, wherein in the middle position is the power is off and the blades are in the blades-open position. By pushing the first end of the rocker switch, the first actuation mode is activated. By pushing the second end of the rocker switch, the second actuation mode is activated. Without actively pressing one of the actuation modes, the rocker switch may spring return to the middle position (blades-open position).

In yet another embodiment, the operating switch can comprise another separate button located at a distance away from the main trigger switch. By activating the separate button, the trigger switch is configured to actuate the first actuation mode when pressed all the way. By not activating the separate button, the trigger switch is configured to activate the second actuation mode when pressed all the way. Or vice versa.

In yet another embodiment, the gripping can be terminated by opening the blades 21, 22 which can be done by operating the separate button or an additional button, when the blade system and the gripped branch are in preferred location, e.g., at ground level. This releases the branch and user can start cutting next branch.

In yet another embodiment, the gripping can be terminated by closing the blades 21, 22 and cutting the branch in two by operating the separate button or the additional button, when the blade system and the gripped branch are in preferred location, e.g., at ground level. This action cuts the branch and releases any potential blade jam that may have occurred when blade is partially penetrated in the branch and is stuck in place because the return spring 208 does not exert enough force to release the blade.

In yet another embodiment, the gripping can be terminated by opening or by closing the blades 21, 22 according to the user's need and operation is controlled by activating the separate button in a predetermined manner. This leaves full control to the user and supports the varying need during pruning work. In praxis, it has been noted that the blade may jam or stuck in the branch when gripping function is used. The prevents the user to release the grip of the branch due to opening of the blades. Therefore, it has been found useful to be able to alternatively cut the branch after gripping when such jam or stuck happens.

In yet another embodiment, the operating switch can alternatively be any switch suitable for changing between at least two positions, such as a slide switch, a push button switch, a rotary switch, or a toggle switch, for example. In yet another embodiment, the operating switch can be two or more switches.

The gripping position is between the blades-open position and the cutting position. For example, the gripping position is at 20-60% length of an operation movement from blades-open position to the cutting position, preferably 40-50%. In an alternative embodiment, at the gripping position, the tips of the first blade 21 and the second blade 22 are less than 10 mm away from each other.

In yet another embodiment, the control system 5 is adapted to control the electric motor 4 in response to information of an electric current supplied to the electric motor 4 to determine the gripping position, wherein exceeding a threshold of the electric current is configured to halt the operation movement of the blade system to the determined gripping position, when actuated to the first actuation mode. Alternatively, the gripping position may be determined by information obtained from a force/moment sensor, wherein exceeding a threshold of the force or torque is configured to halt the operation movement of the blade system to the determined gripping position, when actuated to the first actuation mode.

The aim of the present invention is to provide a safe and controlled way to move the cut branch from the tree to the ground. When utilising the present invention, the user does not need to look out of suddenly fallen tree branches or other debris. The actuation modes are easy and intuitive to use. In the embodiment illustrated in the Figures, only one operating switch is needed.

It is to be understood that the above description and the accompanying figures are only intended to illustrate the present invention. It will be obvious to a person skilled in the art that the invention can be varied and modified without departing from the scope of the invention.

What is claimed is:

1. A tree pruner, comprising:
a pruner body comprising a first body section and a second body section spaced apart in a longitudinal direction of the pruner body,
a blade system connected to the first body section, the blade system comprising a first blade and a second blade adapted to co-operate with each other for cutting branches, wherein the first blade and the second blade are adapted to move relative to each other,
a drive mechanism provided in the second body section, the drive mechanism comprising an operating switch for actuating at least one of the first blade and the second blade,
the operating switch has at least two actuation modes, wherein
by first actuation of the operating switch, the blade system is configured to move from a blades-open position to a gripping position and stay in said gripping position, and
by second actuation of the operating switch, the blade system is configured to move from the blades-open position to a cutting position,
wherein the gripping position is between the blades-open position and the cutting position.

2. The tree pruner of claim 1, wherein the operating switch has a third actuation mode, wherein by third actuation of the operating switch, the blade system is configured to move from the gripping position to the cutting position.

3. The tree pruner of claim 1, wherein the gripping position is at 20-60% length of an operation movement from blades-open position to the cutting position, preferably 40-50%.

4. The tree pruner of claim 1, wherein the drive mechanism comprises an electric motor connected to the second body section and adapted to provide driving power for the blade system, wherein rotation of the electric motor in a first direction is adapted to provide an operation movement in which the blade system moves from the blades-open position towards the gripping position.

5. The tree pruner of claim 4, wherein the drive mechanism further comprises a control system adapted to control the electric motor; and
a transmission system adapted to transfer power from the electric motor to the blade system, the transmission system comprising a transmission rope, wherein a first end of the transmission rope is connected to the blade system, and a second end of the transmission rope is connected to the electric motor such that rotation of the electric motor in the first direction is adapted to pull the first end of the transmission rope towards the second body section in the longitudinal direction.

6. The tree pruner of claim 5, wherein the control system is adapted to control the electric motor to rotate in a second direction as a response to the deactivation of the operating switch.

7. The tree pruner of claim 5, wherein the control system is adapted to control the electric motor in response to information of an electric current supplied to the electric motor to determine the gripping position, wherein exceeding a threshold of the electric current is configured to halt the operation movement of the blade system to the determined gripping position, when actuated to the first actuation mode.

8. The tree pruner of claim 5, wherein the transmission system comprises a rope reel adapted to receive a portion of the transmission rope around it, and the electric motor is adapted to rotate the rope reel.

9. The tree pruner of claim 5, wherein the pruner body comprises at least one tube, and the transmission rope extends inside the at least one tube.

10. The tree pruner of claim 5, wherein the transmission rope comprises non-metallic synthetic material.

11. The tree pruner of claim 1, wherein the operating switch is a trigger switch, a rocker switch, or comprises a separate push button.

12. The tree pruner of claim 1, wherein the first body section further comprises a spring coupled to the second blade biasing the second blade 22 towards the blades-open position.

13. The tree pruner of claim 1, wherein the first body section is adapted to be rotated relative to the second body section around a rotation axis perpendicular to the longitudinal direction of the pruner body.

14. The tree pruner of claim 1, wherein the first blade is stationarily connected relative to the first body section, and the second blade is rotatably connected relative to the first body section, wherein the first blade and second blade are adapted to co-operate as bypass blades for cutting branches.

15. The tree pruner of claim 1, wherein the pruner body has a telescopic structure such that a distance between the first body section and the second body section is adjustable.
